(19) United States
(12) Patent Application Publication
(10) Pub. No.: US 2020/0087468 A1
(43) Pub. Date: Mar. 19, 2020

(54) LASER-INDUCED GRAPHENE FORMATION IN POLYMERS

(71) Applicant: SABIC Global Technologies, B.V., Bergen op Zoom (NL)

(72) Inventors: Shahram Shafaei, Bergen op Zoom (NL); Kapil Chandrakant Sheth, Evansville, IN (US)

(21) Appl. No.: 16/569,140

(22) Filed: Sep. 12, 2019

(30) Foreign Application Priority Data
Sep. 14, 2018 (EP) 18194644.3

(51) Int. Cl. C08J 3/28; C08K 3/04

(52) U.S. Cl. CPC C08J 3/28; B82Y 30/00; C08K 3/042

(57) ABSTRACT

A method for forming a polymer/graphene nanocomposite includes irradiating a polymer comprising an aromatic poly(carbonate-ester), a poly(etherimide-sulfone), or a combination thereof with radiation comprising a wavelength in a range of 8.3 to 11 μm to provide the polymer/graphene nanocomposite.

### CROSS REFERENCE TO RELATED APPLICATIONS

This application claims priority to and the benefit of European Application No. 18194644.3, filed Sep. 14, 2018, and all the benefits accruing therefrom under 35 U.S.C. § 119, the content of which in its entirety is herein incorporated by reference.

### BACKGROUND

Polymer/graphene nanocomposites can have significantly improved properties, such as improved mechanical properties, thermal and electrical conductivities, and gas barrier properties. Distribution of the graphene within the polymer matrix, as well as the interfacial bonding between the graphene and the host matrix are key factors that can affect these properties. Mixing techniques to disperse graphene nanoparticles in a desired polymer matrix include solution casting, melt blending, in situ polymerization, electrospinning, and electrodeposition. Disadvantages of mixing techniques can include aggregation of the graphene nanoparticles, poor dispersion, and noncovalent interactions during the mixing.

Methods for the production of graphene in certain polymers using laser irradiation have been described. However, it would be a further advantage if the methods to could be extended to provide a non-mixing processing method for incorporation of graphene in a variety of polymers, in particular aromatic poly(carbonate-ester)s such as isophthaloyl/terephthaloyl resorcinol poly(carbonate-ester)s, poly(etherimide-sulfone)s, or a combination thereof.

### BRIEF DESCRIPTION

A method for forming a polymer/graphene nanocomposite includes irradiating a an aromatic poly(carbonate-ester), in particular an isophthaloyl/terephthaloyl resorcinol poly(carbonate-ester), a poly(etherimide-sulfone), or a combination thereof with radiation comprising a wavelength in a range of 8.3 to 11 μm, or 8.3 to 10.6 μm to provide the polymer/graphene nanocomposite.

A polymer/graphene nanocomposite formed by the above method is disclosed.

A polymer/graphene nanocomposite includes a polymer comprising an aromatic poly(carbonate-ester), in particular an isophthaloyl/terephthaloyl resorcinol poly(carbonate-ester), a poly(etherimide-sulfone), or a combination thereof; and polymer-derived graphene.

Articles comprising the polymer/graphene nanocomposite are disclosed.

The above described and other features are exemplified by the following figures and detailed description.

### BRIEF DESCRIPTION OF THE DRAWINGS

The following figures are exemplary embodiments wherein the like elements are numbered alike.

FIG. 1 is an SEM image of the laser irradiated polymer of Example 1;

FIG. 2 is a Raman spectrum of the laser irradiated polymer of Example 1;

FIG. 3 is an SEM image of the laser irradiated polymer of Example 2; and

FIG. 4 is a Raman spectrum of the laser irradiated polymer of Example 2.

### DETAILED DESCRIPTION

It has been found that graphene can be produced by laser irradiation of an aromatic poly(carbonate-ester), such as an isophthaloyl/terephthaloyl resorcinol poly(carbonate-ester), a poly(etherimide-sulfone), or a combination thereof. The polymer/graphene nanocomposites can exhibit desirable electrical conductivity and adhesion of the graphene after laser irradiation. The performance of such nanocomposites directly depend on the polymer, the morphology of the substrate, and the laser parameters used.

Laser-induced graphene formation is a non-mixing method to produce polymer/graphene nanocomposites. Graphene as used herein includes undoped graphene and heteroatom-doped graphene such as N-doped quantum dots (NGQDs) and S-doped quantum dots (SGQDs). In an embodiment, the graphene is undoped graphene only. Polymer substrates are exposed to a laser source of a specific wavelength and graphene is formed from the polymer.

The graphene layers are generated on the surface of the polymer substrate, resulting in new surface characteristics. Such characteristic can include increased surface area, thermal conductivity, electrical conductivity, hydrophobicity, antimicrobial properties, or a combination thereof. Laser-induced graphene formation can provide greater conductivity than mixing methods, which typically use graphite and not graphene. Accordingly, laser-induced graphene formation can provide improved conductivity compared to polymers including graphite that are produced by mixing methods.

In some embodiments, laser-induced graphene formation can also be used to produce localized concentrations of graphene in an article. For example, an article (e.g., a substrate layer) can be masked and irradiated to produce graphene in the unmasked regions. This technique allows the production of complex articles that would otherwise need to be manufactured by making graphene-containing and nongraphene-containing parts, and assembling the parts to provide the graphene- and nongraphene-containing regions.

Irradiation conditions, for example, using a carbon dioxide infrared laser, can include a wavelength in a range of 8.3 to 11 μm, or 8.3 to 10.6μm. The polymer can be irradiated using a laser, operating conditions of which can include power in a range of 0.1 to 0.6 W, laser speed in a range of 1.7 to 2.5 cm s⁻¹, pulse duration in a range of 10 to 30 μs, and resolution in a range of 500 to 1,000 pixels per inch (ppi). The particular irradiation conditions used, such as the wavelength, power, pulse, speed, gas environment, or the like, can be adjusted to adjust a property of the polymer/graphene nanocomposites.

The aromatic poly(carbonate-ester)s contain carbonate units and ester units, wherein at least the carbonate units, ester units, or both contain aromatic groups. The carbonate units are of formula (1)

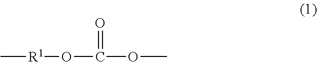

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

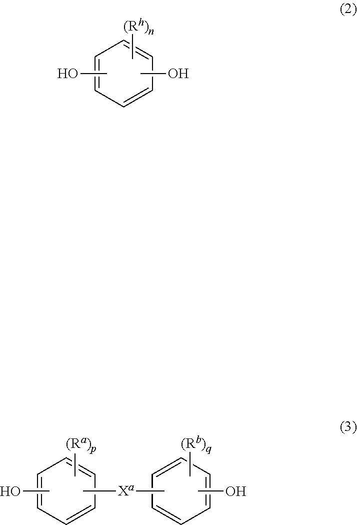

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an embodiment, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Some illustrative examples of dihydroxy compounds that can be used are described, for example, in WO 2013/175448 A1, US 2014/0295363, and WO 2014/072923. Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane, and 1,1-bis(4-hydroxyphenyl)-3,3,5-trimethylcyclohexane (isophorone bisphenol).

The ester unites of the poly(carbonate-ester)s are units of formula (4)

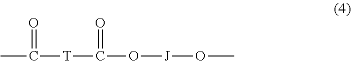

wherein J is a divalent group derived from a dihydroxy compound (which includes a reactive derivative thereof), and can be, for example, a C₁₋₁₀ alkylene, a C₆₋₂₀ cycloalkylene, a C₅₋₂₀ arylene, or a polyoxyalkylene group in which the alkylene groups contain 2 to 6 carbon atoms, specifically, 2, 3, or 4 carbon atoms; and T is a divalent group derived from a dicarboxylic acid (which includes a reactive derivative thereof), and can be, for example, a C₁₋₂₀ alkylene, a C₅₋₂₀ cycloalkylene, or a C₆₋₂₀ arylene. Copolyesters containing a combination of different T or J groups can be used. In an embodiment, at least the J units or the T units are aromatic. In another embodiment, both the J units and the T units are aromatic. The polyester units can be branched or linear.

Specific dihydroxy compounds include aromatic dihydroxy compounds of formula
(2) (e.g., resorcinol), bisphenols of formula (3) (e.g., bisphenol A), a C₁₋₈ aliphatic diol such as ethane diol, n-propane diol, i-propane diol, 1,4-butane diol, 1,4-cyclohexane diol, 1,4-hydroxymethylcyclohexane, or a combination thereof. Aliphatic dicarboxylic acids that can be used include C₅₋₂₀ aliphatic dicarboxylic acids (which includes the terminal carboxyl groups), specifically linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,4-cyclohexane dicarboxylic acid, or combination thereof. A combination of isophthalic acid and terephthalic acid wherein the weight ratio of isophthalic acid to terephthalic acid is 91:9 to 2:98 can be used.

Specific ester units include ethylene terephthalate units, n-proplyene terephthalate units, n-butylene terephthalate units, ester units derived from isophthalic acid, terephthalic acid, and resorcinol (ITR ester units), and ester units derived from sebacic acid and bisphenol A. Preferably, wholly aromatic ester units are used, such as ITR units. The molar ratio of ester units to carbonate units in the poly(carbonate-ester)s can vary broadly, for example 1:99 to 99:1, specifically, 10:90 to 90:10, more specifically, 25:75 to 75:25, or from 2:98 to 15:85. In some embodiments the molar ratio of ester units to carbonate units in the poly(carbonate-ester)s can vary from 1:99 to 30:70, specifically 2:98 to 25:75, more specifically 3:97 to 20:80, or from 5:95 to 15:85.

A preferred poly(carbonate-ester) is fully aromatic. An example of a fully aromatic poly(carbonate-ester) is an isophthaloyl/terephthaloyl resorcinol poly(carbonate-ester) comprising resorcinol isophthalate units, resorcinol terephthalate units, and bisphenol A carbonate units represented by formula (5)

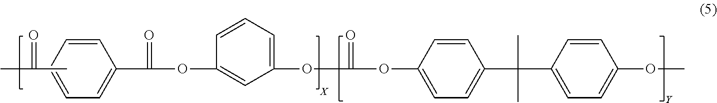

wherein x and y are the number of each unit. These are commercially available under the trade name LEXAN SLX from SABIC.

The aromatic poly(carbonate-ester)s can have an intrinsic viscosity, as determined in chloroform at 25° C., of 0.3 to 1.5 deciliters per gram (dl/gm), specifically 0.45 to 1.0 dl/gm. The polycarbonates can have a weight average molecular weight (Mw) of 2,000 to 200,000 Daltons, specifically 3,000 to 100,000 Daltons, as measured by gel permeation chromatography (GPC), using a crosslinked styrene-divinylbenzene column and calibrated to bisphenol A homopolycarbonate references. GPC samples are prepared at a concentration of 1 mg per ml, and are eluted at a flow rate of 1.5 ml per minute. In a specific embodiment, the aromatic poly(carbonate-esters) are fully aromatic, comprising bisphenol A carbonate units and arylate ester units, specifically ITR units, and can have an Mw of 2,000 to 100,000 Dalton (Da), or 3,000 to 75,000 Da, or 4,000 to 50,000 Da, or 5,000 to 35,000 Da, or 17,000 to 30,000 Da.

Polyetherimides comprise more than 1, for example 2 to 1000, or 5 to 500, or 10 to 100 structural units of formula (6)

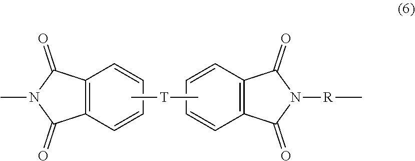

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, or a halogenated derivative of any of the foregoing, provided that at least some R groups contain a sulfone. In some embodiments R is divalent group of one or more of the following formulas (7)

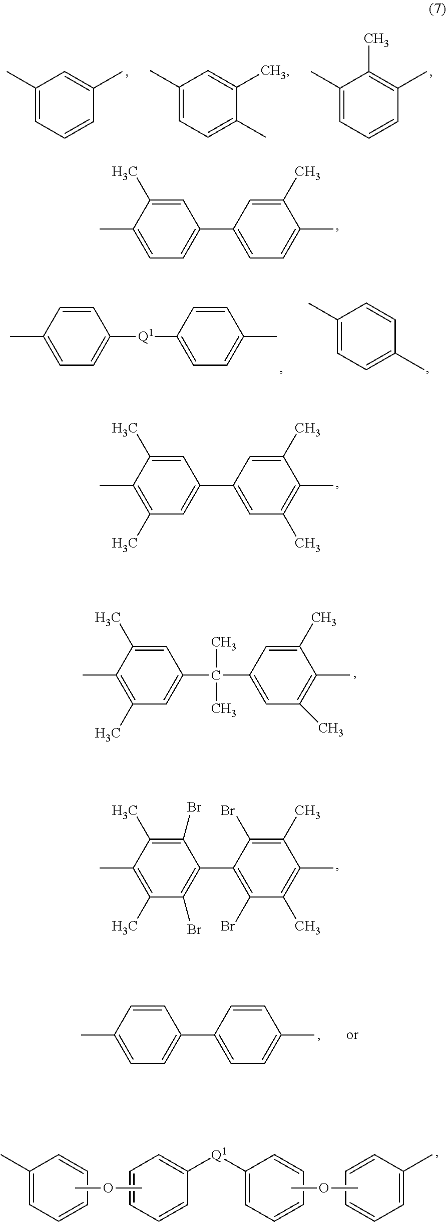

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene or p-phenylene, and a least a portion of the R groups are a diarylene sulfone, in particular bis(4,4′-phenylene)sulfone, bis(3,4′-phenylene)sulfone, bis(3,3′-phenylene)sulfone, or a combination thereof. In some embodiments, at least 10 mole percent or at least 50 mole percent of the R groups contain sulfone groups.

Further in formula (6), T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups of formula (8)

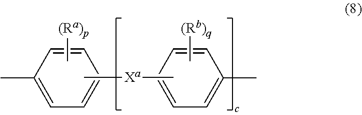

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ is organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (8a)

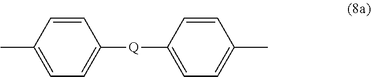

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In a specific embodiment Z is a derived from bisphenol A, such that Q in formula (8a) is 2,2-isopropylidene.

In an embodiment in formula (6), R is m-phenylene, p-phenylene, or a combination thereof wherein at least 50 percent (mol %) of the R groups are bis(4,4′-phenylene)sulfone, bis(3,4′-phenylene)sulfone, bis(3,3′-phenylene)sulfone, or a thereof, and T is —O—Z—O— wherein Z is a divalent group of formula (8a). Alternatively, R is m-phenylene, p-phenylene, or a combination thereof wherein at least 50 mol % of the R groups are bis(4,4′-phenylene)sulfone, bis(3,4′-phenylene)sulfone, bis(3,3′-phenylene)sulfone, or combination thereof, and T is —O—Z—O wherein Z is a divalent group of formula (8a) and Q is 2,2-isopropylidene.

In some embodiments, the poly(etherimide-sulfone) is a copolymer that optionally comprises additional structural imide units that are not polyetherimide units, for example imide units of formula (9)

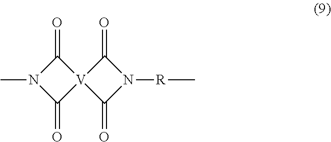

wherein R is as described in formula (6) and each V is the same or different, and is a substituted or unsubstituted C₆₋₂₀ aromatic hydrocarbon group, for example a tetravalent linker of the formulas

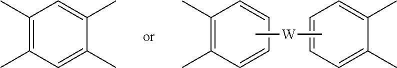

wherein W is a single bond, —O—, —S—, —C(O)—, —SO₂—, —SO—, a C₁₋₁₈ hydrocarbylene group, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide.

The polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide has a weight average molecular weight (Mw) of 1,000 to 150,000 grams/mole (Dalton), as measured by gel permeation chromatography, using polystyrene standards. In some embodiments the polyetherimide has an Mw of 10,000 to 80,000 Daltons. Such polyetherimides typically have an intrinsic viscosity greater than 0.2 deciliters per gram (dl/g), or, more specifically, 0.35 to 0.7 dl/g as measured in m-cresol at 25° C.

In an embodiment, the poly(etherimide-sulfone) can include a phthalic anhydride end group, an example of which is commercially available under the trade name EXTEM XH1015 from SABIC. The graphitization described herein can provide improved properties to the polymers. For example, the polymers can exhibit desirable electrical conductivity. In an embodiment, the polymer/graphene nanocomposite has a volume or surface electrical conductivity of 10 to 1,000 S/m, or other desirable property, for example a gas barrier property. In a further advantage, the graphene particles can exhibit good adhesion to the polymer matrix after laser irradiation. Use of irradiation to produce polymer/graphene nanocomposites can obviate one or more disadvantages of using mixing methods to manufacture such nanocomposites. For example, the graphene can be homogenously distributed in the polymer.

A polymer/graphene nanocomposite comprises polymer-derived graphene and a polymer comprising an aromatic poly(carbonate-ester) such as an isophthaloyl/terephthaloyl resorcinol poly(carbonate-ester), a poly(etherimide-sulfone), or a combination thereof.

Articles comprising the polymer/graphene nanocomposite are disclosed.

This disclosure is further illustrated by the following examples, which are non-limiting.

### EXAMPLES

Components used in the Examples and Comparative Examples are provided in Table 1.

TABLE 1

| Component | Description | Source |
|---|---|---|
| PC | Polycarbonate blend comprising a high flow PC | SABIC |
| | having an Mw of 19,000 to 34,000 Da and a low | |
| | flow PC having an Mw of 35,000 to 89,000 kDa | |
| | (trade name LEXAN 141R) | |
| ITR-PC | Isophthaloyl/terephthaloyl resorcinol | SABIC |
| | poly(carbonate-ester) (trade name SLX) | |
| PEI-S | Poly(etherimide-sulfone) | SABIC |
| | (trade name EXTEM XH1015) | |

Compounding and extrusion were performed at standard conditions. In particular, extrusion of all materials was performed on a 25 mm Wemer-Pfleiderer ZAK twin-screw extruder (L/D ratio of 33/1) with a vacuum port located near the die face. The extruder has 9 zones, which were set at temperatures of 40° C. (feed zone), 200° C. (zone 1), 250° C. (zone 2), 270° C. (zone 3), and 280-300° C. (zone 4 to 8). Screw speed was 300 rpm and throughput was between 15 and 25 kg/hr.

For testing, color plaques (60×60×2.0 millimeters (mm)) were prepared by drying the compositions at 135° C. for 4 hours, then by molding after on a 45-ton Engel molding machine with 22 mm screw or 75-ton Engel molding machine with 30 mm screw operating at a temperature around 310° C. with a mold temperature of 100° C. Films (210×297×0.250 mm and 210×297×0.250 mm) were obtained from SABIC.

Carbon dioxide infrared laser irradiation conditions for the Comparative Examples and the Examples are provided in Table 2. Irradiation was further conducted under ambient conditions of temperature and pressure.

TABLE 2

| Parameter | Value |
|---|---|
| Wavelength (μm) | 10.6 |
| Power (W) | 0.1-0.6 |
| Laser speed (cm s⁻¹) | 1.7-2.5 |
| Pulse duration (μs) | 14.6 |
| Resolution (ppi) | 600 |

Melt volume rate (MVR) was determined at 360° C./5.0 kg or at 360° C./5.0 kg in accordance with ISO 1133. Results are reported in units of cm³/10 minutes. Viscosity is equal to an inverse of the MVR.

The overall microstructural properties of polymer/graphene nanocomposites were studied by scanning electron microscopy (SEM).

Specific surface area (porosity) was determined using SEM. A scanning electron microscope (ESEM, JSF 7800F, JEOL, Tokyo, Japan) was used to acquire micrographs of graphene nanocomposite 3D sponge and microstructures and fiber like microstructures with dispersion of graphene nanoparticles at an acceleration voltage of 10 kV. For SEM examination, the samples were sputter-coated with Pd/Pt.

Raman spectroscopy (Bruker Senterra dispersive microscope Raman) was used to confirm creation of graphene after laser irradiation for various samples at laser wavelength 532 nm (2 Mw) with objective of 100× in scanning range 4400-200 cm⁻¹.

Degree of graphitization was determined by calculating intensity of peaks (2D, G, D) position, shape of spectra, according to ISO TC 201 (Surface Chemical Analysis) and further according to the Versailles Project on Advanced Materials and Standards by VAMAS TWA41—Graphene and VAMAS TWA42—Raman. The polymer/graphene nanocomposite formed by the irradiation can have a degree of graphitization of 0.5 to 2.0, for example 0.5 to 1.0.

Electrical volume resistivity measurements were conducted in a thickness direction using Jandel 4-point probe with spacing of 1 mm at 90 volts (V), according to ASTM 257-75, and converted to conductivity values. Each conductivity value reported is an average of the calculated conductivity at ten locations along a line on the sample.

As used herein, “2D band” can be correlated to a single graphene layer. Single layer graphene can also be identified by analyzing the peak intensity ratio of the 2D and G bands.

The adhesion of graphene particles to the polymer were determined by tape film, and are reported relative to each other, where each “+” indicates better adhesion.

The compositions of Examples 1 and 2 (Ex1-2) and Comparative Example 1 (CEx1) are shown in Table 3, together with their measured properties. The amount of each component is in volume percent, based on the total volume of the composition, and totals 100.00 volume percent. The MVR of Comparative Example 1 and Example 1 was determined at 300° C./1.2 kg in accordance with ISO 1133, and the MVR of Example 2 was determined at 360° C./5.0 kg in accordance with ISO 1133.

TABLE 3

| | Unit | CEx1 | Ex1 | Ex2 |
|---|---|---|---|---|
| Component | | | | |
| PC | vol % | 100.00 | | |
| ITR-PC | vol % | | 100.00 | |
| PEI-Sulfone | vol % | | | 100.00 |
| Properties | | | | |
| MVR (300° C./1.2 kg) | cm³/10 min | 12 | 9 | |
| MVR (360° C./5.0 kg) | cm³/10 min | | | 13 |
| Electrical conductivity before laser irradiation | S/m | 0 | 0 | 0 |
| Electrical conductivity after laser irradiation | S/m | 0 | 70 | 250 |
| Specific surface area before laser irradiation | m² · g⁻¹ | 0 | 0 | 0 |
| Specific surface area after laser irradiation | m² · g⁻¹ | 0 | 300 | 150 |
| Degree of graphitization before laser irradiation | — | 0 | 0 | 0 |
| Degree of graphitization after laser irradiation | — | — | 0.76 | 0.70 |
| 2D band before laser irradiation | — | No | No | No |
| 2D band after laser irradiation | — | No | Yes | Yes |
| Adhesion of graphene particles to polymer before laser irradiation | — | — | — | — |
| Adhesion of graphene particles on polymer after laser irradiation | — | — | + | + |

### Example 1—ITR-PC

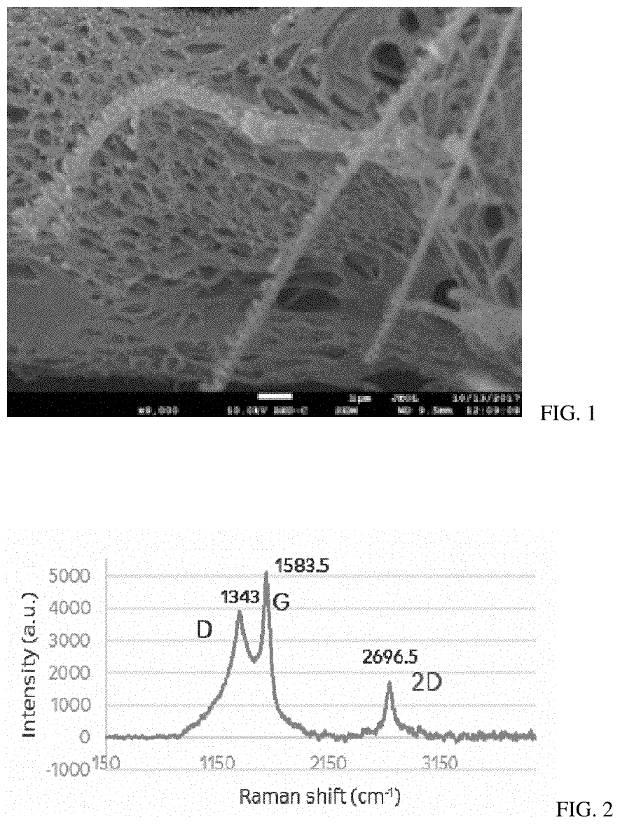

An SEM image of Ex1 showed 3-dimensional pores microstructures with fiber graphene nanocomposites after laser irradiation (FIG. 1). Raman spectroscopy confirmed graphitization of Ex1 by laser irradiation, by the presence of D, G and 2D peaks (FIG. 2). The 2D peak at 2,700 cm¹ corresponds to a single layer graphene with electrical conductivity around 6,000 S/cm.

### Example 2—PEI-S

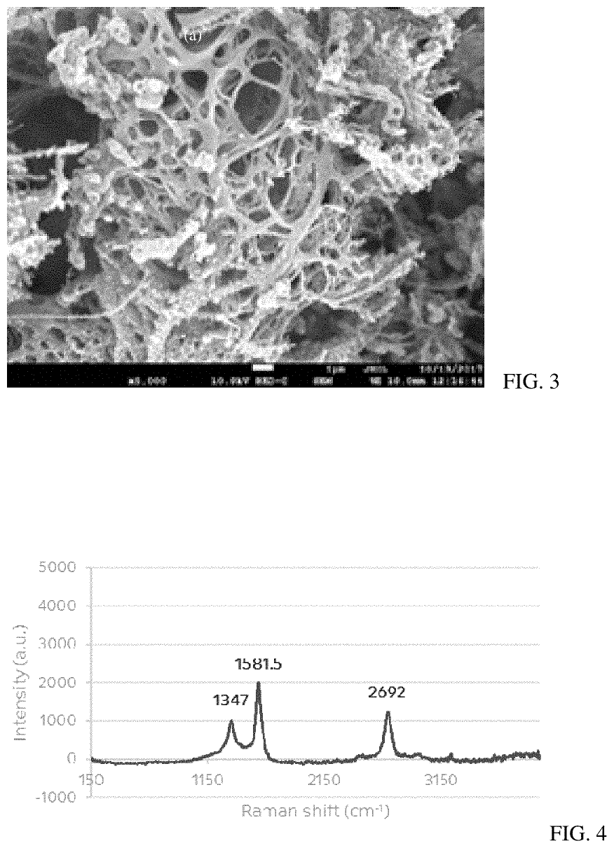

An SEM image of Ex2 showed 3-dimensional pores fiber like microstructures with dispersion of graphene nanoparticles on the fibers after laser irradiation (FIG. 3). Raman spectroscopy confirmed graphitization of Ex1 by laser irradiation, by the presence of D, G and 2D peaks (FIG. 4). The 2D peak at 2,700 cm⁻¹ corresponds to a single layer graphene with electrical conductivity around 6,000 S/cm.

This disclosure further encompasses the following aspects.

Aspect 1. A method for forming a polymer/graphene nanocomposite, the method comprising irradiating a polymer comprising an aromatic poly(carbonate-ester), a poly(etherimide-sulfone), or a combination thereof with radiation comprising a wavelength in a range of 8.3 to 11 μm, or 8.3 to 10.6 μm to provide the polymer/graphene nanocomposite.

Aspect 2. The method according to Aspect 1, wherein irradiating the polymer comprises using a laser, and operating conditions of the laser comprise power in a range of 0.1 to 0.6 W, laser speed in a range of 1.7 to 2.5 cm s⁻¹, pulse duration in a range of 10 to 30 μs, and resolution in a range of 500 to 1,000 ppi.

Aspect 3. The method according to Aspect 2, further comprising adjusting one or more of the operating conditions of the laser to adjust a property of the polymer/graphene nanocomposite.

Aspect 4. The method according to any preceding aspect, wherein the polymer comprises the an aromatic poly(carbonate-ester), preferably a fully aromatic an aromatic poly(carbonate-ester), more preferably an isophthaloyl/terephthaloyl resorcinol poly(carbonate-ester).

Aspect 5. The method according to any of Aspects 1-3, wherein the polymer comprises a poly(etherimide-sulfone).

Aspect 6. The method according to any preceding aspect, wherein the polymer comprising the polymer/graphene nanocomposite has an electrical conductivity of 10 to 1,000 S/m, measured according to ASTM 257-75.

Aspect 7. The method according to any preceding aspect, wherein the polymer comprising the polymer/graphene nanocomposite has a degree of graphitization of 0.5 to 2, measured according to ISO TC 201 (Surface Chemical Analysis) and further according to the Versailles Project on Advanced Materials and Standards by VAMAS TWA41—Graphene and VAMAS TWA42—Raman.

Aspect 8. A polymer/graphene nanocomposites formed by the method of any preceding aspect.

Aspect 9. A polymer/graphene nanocomposites comprising a polymer comprising an aromatic poly(carbonate-ester), a poly(etherimide-sulfone), or a combination thereof; and polymer-derived graphene.

Aspect 10. The composition according to Aspect 9, wherein the composition has an electrical conductivity of 10 to 1,000 S/m, measured according to ASTM 257-75.

Aspect 11. An article comprising polymer/graphene nanocomposites of any of Aspects 9 to 10.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The term “a combination thereof” in reference to a list of alternatives is open, i.e., includes at least one of the listed alternatives, optionally with a like alternative nots listed. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method for forming a polymer/graphene nanocomposite, the method comprising:
irradiating a polymer comprising an aromatic poly(carbonate-ester), a poly(etherimide-sulfone), or a combination thereof with radiation comprising a wavelength in a range of 8.3 to 11 μm to provide the polymer/graphene nanocomposite.

2. The method according to claim 1, wherein:
irradiating the polymer comprises using a laser, and
operating conditions of the laser comprise power in a range of 0.1 to 0.6 W, laser speed in a range of 1.7 to 2.5 cm s⁻¹, pulse duration in a range of 10 to 30 μs, and resolution in a range of 500 to 1,000 ppi.

3. The method according to claim 2, further comprising adjusting one or more of the operating conditions of the laser to adjust a property of the polymer/graphene nanocomposite.

4. The method according to claim 1, wherein the polymer comprises an aromatic poly(carbonate-ester).

5. The method according to claim 1, wherein the polymer comprises a fully aromatic an aromatic poly(carbonate-ester).

6. The method according to claim 1, wherein the polymer comprises an isophthaloyl/terephthaloyl resorcinol poly(carbonate-ester).

7. The method according to claim 1, wherein the polymer comprises a poly(etherimide-sulfone).

8. The method according to claim 1, wherein the polymer/graphene nanocomposite has an electrical conductivity of 10 to 1,000 S/m, measured according to ASTM 257-75.

9. The method according to claim 1, wherein the polymer comprising the polymer/graphene nanocomposite has a degree of graphitization of 0.5 to 2, measured according to ISO TC 201 (Surface Chemical Analysis) and further according to the Versailles Project on Advanced Materials and Standards by VAMAS TWA41—Graphene and VAMAS TWA42—Raman.

10. A polymer/graphene nanocomposite formed by the method of claim 1.

11. A polymer/graphene nanocomposite, comprising:
a polymer comprising an aromatic poly(carbonate-ester), a poly(etherimide-sulfone), or a combination thereof; and
polymer-derived graphene.

12. The polymer/graphene nanocomposite according to claim 9, wherein the polymer/graphene nanocomposite has an electrical conductivity of 10 to 1,000 S/m, measured according to ASTM 257-75.

13. An article comprising the polymer/graphene nanocomposite of claim 11.
